(19) United States
(12) Patent Application Publication
(10) Pub. No.: US 2014/0149130 A1
(43) Pub. Date: May 29, 2014

(54) HEALTHCARE FRAUD DETECTION BASED ON STATISTICS, LEARNING, AND PARAMETERS

(71) Applicant: VERIZON PATENT AND LICENSING INC., Basking Ridge, NJ (US)

(72) Inventor: Jeffrey M. GETCHIUS, Cambridge, MA (US)

(73) Assignee: VERIZON PATENT AND LICENSING INC., Basking Ridge, NJ (US)

(21) Appl. No.: 13/689,231

(22) Filed: Nov. 29, 2012

(51) Int. Cl. G06Q 50/22

(52) U.S. Cl. CPC G06Q 50/22
USPC 705/2

(57) ABSTRACT

A system receives healthcare information, and calculates a geographic density of healthcare fraud based on the healthcare information. The system derives empirical estimates of procedure and treatment durations based on the healthcare information, and utilizes classifiers to determine inconsistencies in the healthcare information. The system calculates parameters for a healthcare fraud detection system based on the geographic density, the empirical estimates, and the inconsistencies, and provides the parameters to the healthcare fraud detection system.

### BACKGROUND

Healthcare fraud is a sizeable and significant challenge for the healthcare and insurance industries, and costs these industries billions of dollars each year. Healthcare fraud is a significant threat to most healthcare programs, such as government sponsored programs and private programs. Currently, healthcare providers, such as doctors, pharmacies, hospitals, etc., provide healthcare services to beneficiaries, and submit healthcare claims for the provision of such services. The healthcare claims are provided to a clearinghouse that makes minor edits to the claims, and provides the edited claims to a claims processor. The claims processor, in turn, processes, edits, and/or pays the healthcare claims. The clearinghouse and/or the claims processor may be associated with one or more private or public health insurers and/or other healthcare entities.

After paying the healthcare claims, the claims processor forwards the paid claims to a zone program integrity contractor. The zone program integrity contractor reviews the paid claims to determine whether any of the paid claims are fraudulent. A recovery audit contractor may also review the paid claims to determine whether any of them are fraudulent. In one example, the paid claims may be reviewed against a black list of suspect healthcare providers. If the zone program integrity contractor or the recovery audit contractor discovers a fraudulent healthcare claim, they may attempt to recover the monies paid for the fraudulent healthcare claim. However, such after-the-fact recovery methods (e.g., pay and chase methods) are typically unsuccessful since an entity committing the fraud may be difficult to locate due to the fact that the entity may not be a legitimate person, organization, business, etc. Furthermore, relying on law enforcement agencies to track down and prosecute such fraudulent entities may prove fruitless since law enforcement agencies lack the resources to handle healthcare fraud and it may require a long period of time to build a case against the fraudulent entities.

### BRIEF DESCRIPTION OF THE DRAWINGS

FIG. 1 is a diagram of an overview of an implementation described herein;

FIG. 2 is a diagram that illustrates an example environment in which systems and/or methods, described herein, may be implemented;

FIG. 3 is a diagram of example components of a device that may be used within the environment of FIG. 2;

FIG. 4 is a diagram of example interactions between components of an example portion of the environment depicted in FIG. 2;

FIG. 5 is a diagram of example functional components of a healthcare fraud management system of FIG. 2;

FIG. 6 is a diagram of example functional components of a healthcare fraud detection system of FIG. 5;

FIG. 7 is a diagram of example functional components of a healthcare fraud analysis system of FIG. 5;

FIG. 8 is a diagram of example operations capable of being performed by a classifiers component of FIG. 7;

FIG. 9 is a diagram of example functional components of a geography component of FIG. 7;

FIGS. 10-13 are diagrams of example geographic maps capable of being generated by the geography component of FIG. 7;

FIG. 14 is a diagram of example functional components of a linear programming component of FIG. 7; and

FIGS. 15-17 are flowcharts of an example process for detecting healthcare fraud based on statistics, learning, and parameters.

### DETAILED DESCRIPTION OF PREFERRED EMBODIMENTS

The following detailed description refers to the accompanying drawings. The same reference numbers in different drawings may identify the same or similar elements.

Systems and/or methods described herein may detect healthcare fraud based on statistics, learning, and/or parameters. In one example, the systems and/or methods may receive healthcare information (e.g., associated with providers, beneficiaries, etc.), and may calculate a geographic density of fraud based on the healthcare information. Based on the healthcare information, the systems and/or methods may derive empirical estimates of procedure/treatment durations. The systems and/or methods may utilize classifiers to determine inconsistencies in the healthcare information. The systems and/or methods may calculate parameters for a healthcare fraud monitoring system based on the geographic density of fraud, the empirical estimates, and/or the inconsistencies, and may provide the calculated parameters to a healthcare fraud monitoring system.

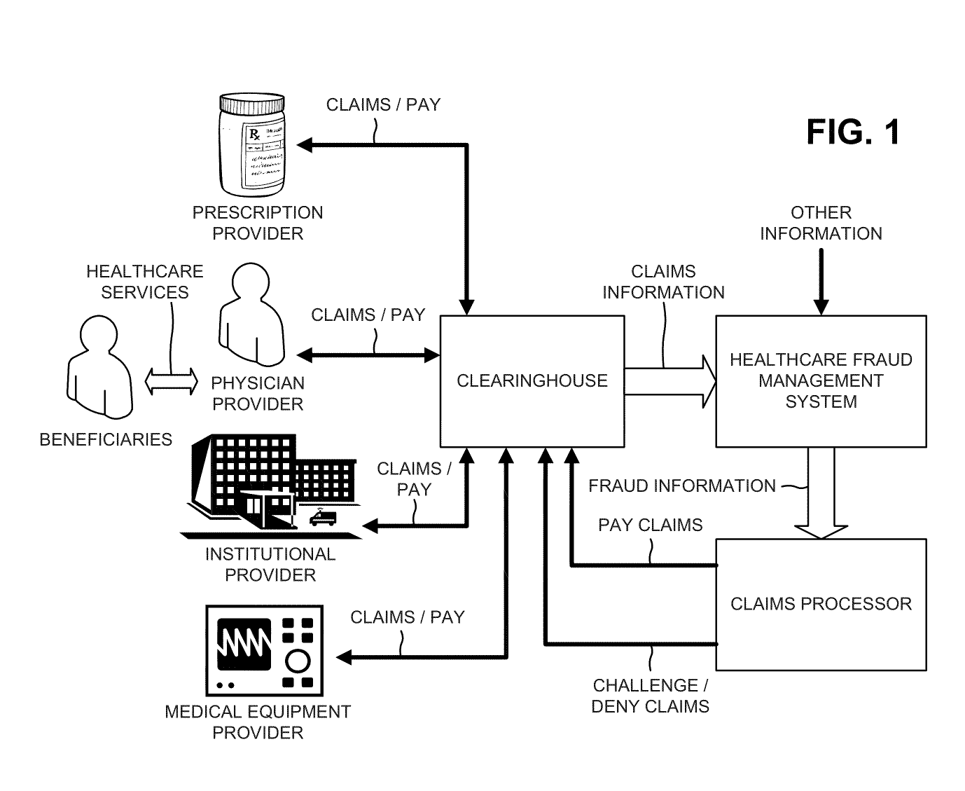

FIG. 1 is a diagram of an overview of an implementation described herein. For the example of FIG. 1, assume that beneficiaries receive healthcare services from a provider, such as a prescription provider, a physician provider, an institutional provider, a medical equipment provider, etc. The term “beneficiary,” as used herein, is intended to be broadly interpreted to include a member, a person, a business, an organization, or some other type of entity that receives healthcare services, such as prescription drugs, surgical procedures, doctor's office visits, physicals, hospital care, medical equipment, etc. from a provider. The term “provider,” as used herein, is intended to be broadly interpreted to include a prescription provider (e.g., a drug store, a pharmaceutical company, an online pharmacy, a brick and mortar pharmacy, etc.), a physician provider (e.g., a doctor, a surgeon, a physical therapist, a nurse, a nurse assistant, etc.), an institutional provider (e.g., a hospital, a medical emergency center, a surgery center, a trauma center, a clinic, etc.), a medical equipment provider (e.g., diagnostic equipment provider, a therapeutic equipment provider, a life support equipment provider, a medical monitor provider, a medical laboratory equipment provider, a home health agency, etc.), etc.

After providing the healthcare services, the provider may submit claims to a clearinghouse. The terms “claim” or “healthcare claim,” as used herein, are intended to be broadly interpreted to include an interaction of a provider with a clearinghouse, a claims processor, or another entity responsible for paying for a beneficiary's healthcare or medical expenses, or a portion thereof. The interaction may involve the payment of money, a promise for a future payment of money, the deposit of money into an account, or the removal of money from an account. The term “money,” as used herein, is intended to be broadly interpreted to include anything that can be accepted as payment for goods or services, such as currency, coupons, credit cards, debit cards, gift cards, and funds held in a financial account (e.g., a checking account, a money market account, a savings account, a stock account, a mutual fund account, a paypal account, etc.). The clearinghouse may make minor changes to the claims, and may provide information associated with the claims, such as provider information, beneficiary information, healthcare service information, etc., to a healthcare fraud management system.

In one implementation, each healthcare claim may involve a one time exchange of information, between the clearinghouse and the healthcare fraud management system, which may occur in near real-time to submission of the claim to the clearinghouse and prior to payment of the claim. Alternatively, or additionally, each healthcare claim may involve a series of exchanges of information, between the clearinghouse and the healthcare fraud management system, which may occur prior to payment of the claim.

The healthcare fraud management system may receive the claims information from the clearinghouse and may obtain other information regarding healthcare fraud from other systems. For example, the other healthcare fraud information may include information associated with providers under investigation for possible fraudulent activities, information associated with providers who previously committed fraud, information provided by zone program integrity contractors (ZPICs), information provided by recovery audit contractors, etc. The information provided by the zone program integrity contractors may include cross-billing and relationships among healthcare providers, fraudulent activities between Medicare and Medicaid claims, whether two insurers are paying for the same services, amounts of services that providers bill, etc. The recovery audit contractors may provide information about providers whose billings for services are higher than the majority of providers in a community, information regarding whether beneficiaries received healthcare services and whether the services were medically necessary, information about suspended providers, information about providers that order a high number of certain items or services, information regarding high risk beneficiaries, etc. The healthcare fraud management system may use the claims information and the other information to facilitate the processing of a particular claim. In one example implementation, the healthcare fraud management system may not be limited to arrangements such as Medicare (private or public) or other similar mechanisms used in the private industry, but rather may be used to detect fraudulent activities in any healthcare arrangement.

For example, the healthcare fraud management system may process the claim using sets of rules, selected based on information relating to a claim type and the other information, to generate fraud information. The healthcare fraud management system may output the fraud information to the claims processor to inform the claims processor whether the particular claim potentially involves fraud. The fraud information may take the form of a fraud score or may take the form of an “accept” alert (meaning that the particular claim is not fraudulent) or a “reject” alert (meaning that the particular claim is potentially fraudulent or that “improper payments” were paid for the particular claim). The claims processor may then decide whether to pay the particular claim or challenge/deny payment for the particular claim based on the fraud information.

In some scenarios, the healthcare fraud management system may detect potential fraud in near real-time (i.e., while the claim is being submitted and/or processed). In other scenarios, the healthcare fraud management system may detect potential fraud after the claim is submitted (perhaps minutes, hours, or days later) but prior to payment of the claim. In either scenario, the healthcare fraud management system may reduce financial loss contributable to healthcare fraud. In addition, the healthcare fraud management system may help reduce health insurer costs in terms of software, hardware, and personnel dedicated to healthcare fraud detection and prevention.

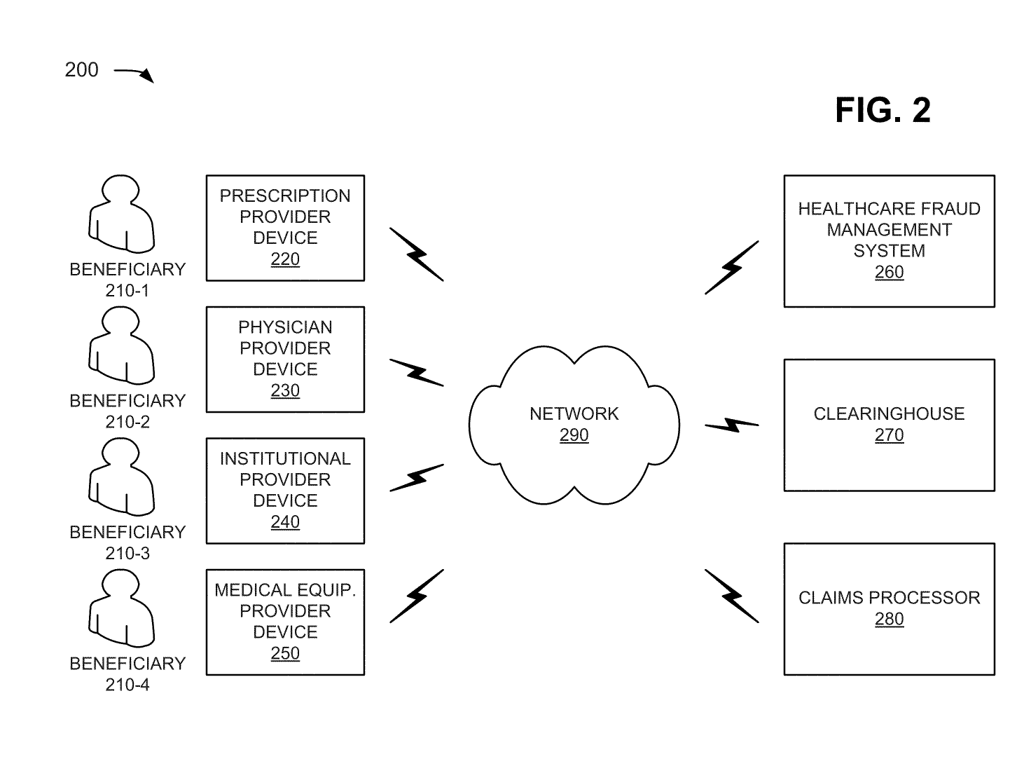

FIG. 2 is a diagram that illustrates an example environment 200 in which systems and/or methods, described herein, may be implemented. As shown in FIG. 2, environment 200 may include beneficiaries 210-1, . . . , 210-4 (collectively referred to as “beneficiaries 210,” and individually as “beneficiary 210”), a prescription provider device 220, a physician provider device 230, an institutional provider device 240, a medical equipment provider device 250, a healthcare fraud management system 260, a clearinghouse 270, a claims processor 280, and a network 290.

While FIG. 2 shows a particular number and arrangement of devices, in practice, environment 200 may include additional devices, fewer devices, different devices, or differently arranged devices than are shown in FIG. 2. Also, although certain connections are shown in FIG. 2, these connections are simply examples and additional or different connections may exist in practice. Each of the connections may be a wired and/or wireless connection. Further, each prescription provider device 220, physician provider device 230, institutional provider device 240, and medical equipment provider device 250 may be implemented as multiple, possibly distributed, devices.

Beneficiary 210 may include a person, a business, an organization, or some other type of entity that receives healthcare services, such as services provided by a prescription provider, a physician provider, an institutional provider, a medical equipment provider, etc. For example, beneficiary 210 may receive prescription drugs, surgical procedures, doctor's office visits, physicals, hospital care, medical equipment, etc. from one or more providers.

Prescription provider device 220 may include a device, or a collection of devices, capable of interacting with clearinghouse 270 to submit a healthcare claim associated with healthcare services provided to a beneficiary 210 by a prescription provider. For example, prescription provider device 220 may correspond to a communication device (e.g., a mobile phone, a smartphone, a personal digital assistant (PDA), or a wireline telephone), a computer device (e.g., a laptop computer, a tablet computer, or a personal computer), a set top box, or another type of communication or computation device. As described herein, a prescription provider may use prescription provider device 220 to submit a healthcare claim to clearinghouse 270.

Physician provider device 230 may include a device, or a collection of devices, capable of interacting with clearinghouse 270 to submit a healthcare claim associated with healthcare services provided to a beneficiary 210 by a physician provider. For example, physician provider device 230 may correspond to a computer device (e.g., a server, a laptop computer, a tablet computer, or a personal computer). Additionally, or alternatively, physician provider device 230 may include a communication device (e.g., a mobile phone, a smartphone, a PDA, or a wireline telephone) or another type of communication or computation device. As described herein, a physician provider may use physician provider device 230 to submit a healthcare claim to clearinghouse 270.

Institutional provider device 240 may include a device, or a collection of devices, capable of interacting with clearinghouse 270 to submit a healthcare claim associated with healthcare services provided to a beneficiary 210 by an institutional provider. For example, institutional provider device 240 may correspond to a computer device (e.g., a server, a laptop computer, a tablet computer, or a personal computer). Additionally, or alternatively, institutional provider device 240 may include a communication device (e.g., a mobile phone, a smartphone, a PDA, or a wireline telephone) or another type of communication or computation device. As described herein, an institutional provider may use institutional provider device 240 to submit a healthcare claim to clearinghouse 270.

Medical equipment provider device 250 may include a device, or a collection of devices, capable of interacting with clearinghouse 270 to submit a healthcare claim associated with healthcare services provided to a beneficiary 210 by a medical equipment provider. For example, medical equipment provider device 250 may correspond to a computer device (e.g., a server, a laptop computer, a tablet computer, or a personal computer). Additionally, or alternatively, medical equipment provider device 250 may include a communication device (e.g., a mobile phone, a smartphone, a PDA, or a wireline telephone) or another type of communication or computation device. As described herein, a medical equipment provider may use medical equipment provider device 250 to submit a healthcare claim to clearinghouse 270.

Healthcare fraud management system 260 may include a device, or a collection of devices, that performs fraud analysis on healthcare claims in near real-time. Healthcare fraud management system 260 may receive claims information from clearinghouse 270, may receive other healthcare information from other sources, may perform fraud analysis with regard to the claims information and in light of the other information and claim types, and may provide, to claims processor 280, information regarding the results of the fraud analysis.

In one implementation, healthcare fraud management system 260 may provide near real-time fraud detection tools with predictive modeling and risk scoring, and may provide end-to-end case management and claims review processes. Healthcare fraud management system 260 may also provide comprehensive reporting and analytics. Healthcare fraud management system 260 may monitor healthcare claims, prior to payment, in order to detect fraudulent activities before claims are forwarded to adjudication systems, such as claims processor 280.

Alternatively, or additionally, healthcare fraud management system 260 may receive healthcare information (e.g., associated with providers, beneficiaries, etc.), and may calculate a geographic density of fraud based on the healthcare information. Based on the healthcare information, healthcare fraud management system 260 may determine anomalous distributions of fraud, and may derive empirical estimates of procedure/treatment durations. Healthcare fraud management system 260 may utilize classifiers, language models, co-morbidity analysis, and/or link analysis to determine inconsistencies in the healthcare information. Healthcare fraud management system 260 may calculate parameters for a detection system, of healthcare fraud management system 260, based on the geographic density of fraud, the anomalous distributions of fraud, the empirical estimates, and/or the inconsistencies, and may provide the calculated parameters to the detection system.

Clearinghouse 270 may include a device, or a collection of devices, that receives healthcare claims from a provider, such as one of provider devices 220-250, makes minor edits to the claims, and provides the edited claims to healthcare fraud management system 260, or to claims processor 280 and then to healthcare fraud management system 260. In one example, clearinghouse 270 may receive a healthcare claim from one of provider devices 220-250, and may check the claim for minor errors, such as incorrect beneficiary information, incorrect insurance information, etc. Once the claim is checked and no minor errors are discovered, clearinghouse 270 may securely transmit the claim to healthcare fraud management system 260.

Claims processor 280 may include a device, or a collection of devices, that receives a claim, and information regarding the results of the fraud analysis for the claim, from healthcare fraud management system 260. If the fraud analysis indicates that the claim is not fraudulent, claims processor 280 may process, edit, and/or pay the claim. However, if the fraud analysis indicates that the claim may be fraudulent, claims processor 280 may deny the claim and may perform a detailed review of the claim. The detailed analysis of the claim by claims processor 280 may be further supported by reports and other supporting documentation provided by healthcare fraud management system 260.

Network 290 may include any type of network or a combination of networks. For example, network 290 may include a local area network (LAN), a wide area network (WAN) (e.g., the Internet), a metropolitan area network (MAN), an ad hoc network, a telephone network (e.g., a Public Switched Telephone Network (PSTN), a cellular network, or a voice-over-IP (VoIP) network), an optical network (e.g., a FiOS network), or a combination of networks. In one implementation, network 290 may support secure communications between provider devices 220-250, healthcare fraud management system 260, clearinghouse 270, and/or claims processor 280. These secure communications may include encrypted communications, communications via a private network (e.g., a virtual private network (VPN) or a private IP VPN (PIP VPN)), other forms of secure communications, or a combination of secure types of communications.

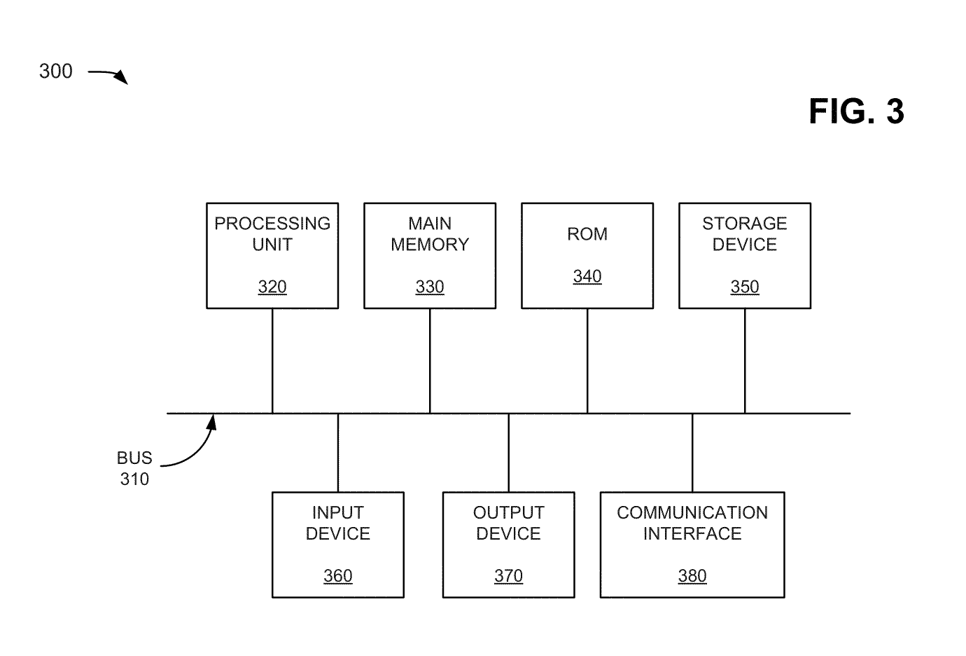

FIG. 3 is a diagram of example components of a device 300. Device 300 may correspond to prescription provider device 220, physician provider device 230, institutional provider device 240, medical equipment provider device 250, healthcare fraud management system 260, clearinghouse 270, or claims processor 280. Each of prescription provider device 220, physician provider device 230, institutional provider device 240, medical equipment provider device 250, healthcare fraud management system 260, clearinghouse 270, and claims processor 280 may include one or more devices 300. As shown in FIG. 3, device 300 may include a bus 310, a processing unit 320, a main memory 330, a read only memory (ROM) 340, a storage device 350, an input device 360, an output device 370, and a communication interface 380.

Bus 310 may include a path that permits communication among the components of device 300. Processing unit 320 may include one or more processors, one or more microprocessors, one or more application specific integrated circuits (ASICs), one or more field programmable gate arrays (FPGAs), or one or more other types of processors that interpret and execute instructions. Main memory 330 may include a random access memory (RAM) or another type of dynamic storage device that stores information or instructions for execution by processing unit 320. ROM 340 may include a ROM device or another type of static storage device that stores static information or instructions for use by processing unit 320. Storage device 350 may include a magnetic storage medium, such as a hard disk drive, or a removable memory, such as a flash memory.

Input device 360 may include a mechanism that permits an operator to input information to device 300, such as a control button, a keyboard, a keypad, or another type of input device. Output device 370 may include a mechanism that outputs information to the operator, such as a light emitting diode (LED), a display, or another type of output device. Communication interface 380 may include any transceiver-like mechanism that enables device 300 to communicate with other devices or networks (e.g., network 290). In one implementation, communication interface 380 may include a wireless interface and/or a wired interface.

Device 300 may perform certain operations, as described in detail below. Device 300 may perform these operations in response to processing unit 320 executing software instructions contained in a computer-readable medium, such as main memory 330. A computer-readable medium may be defined as a non-transitory memory device. A memory device may include space within a single physical memory device or spread across multiple physical memory devices.

The software instructions may be read into main memory 330 from another computer-readable medium, such as storage device 350, or from another device via communication interface 380. The software instructions contained in main memory 330 may cause processing unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows example components of device 300, in other implementations, device 300 may include fewer components, different components, differently arranged components, and/or additional components than those depicted in FIG. 3. Alternatively, or additionally, one or more components of device 300 may perform one or more tasks described as being performed by one or more other components of device 300.

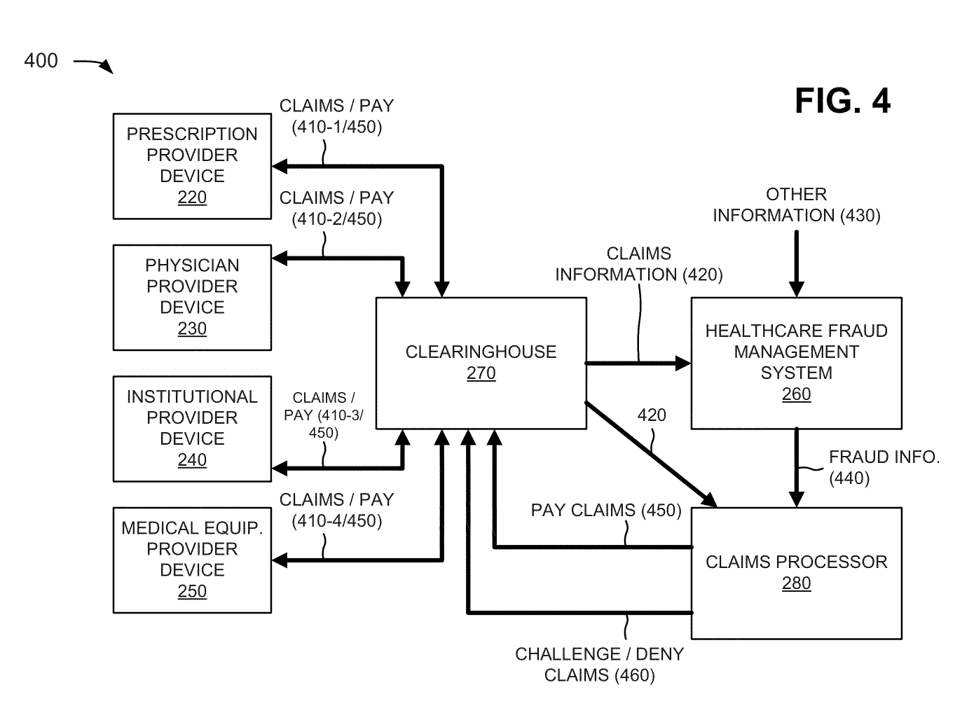

FIG. 4 is a diagram of example interactions between components of an example portion 400 of environment 200. As shown, example portion 400 may include prescription provider device 220, physician provider device 230, institutional provider device 240, medical equipment provider device 250, healthcare fraud management system 260, clearinghouse 270, and claims processor 280. Prescription provider device 220, physician provider device 230, institutional provider device 240, medical equipment provider device 250, healthcare fraud management system 260, clearinghouse 270, and claims processor 280 may include the features described above in connection with, for example, one or more of FIGS. 2 and 3.

Beneficiaries (not shown) may or may not receive healthcare services from a provider associated with prescription provider device 220, physician provider device 230, institutional provider device 240, and/or medical equipment provider device 250. As further shown in FIG. 4, whether or not the providers legitimately provided the healthcare services to the beneficiaries, prescription provider device 220 may generate claims 410-1, physician provider device 230 may generate claims 410-2, institutional provider device 240 may generate claims 410-3, and medical equipment provider device 250 may generate claims 410-4. Claims 410-1, . . . , 410-4 (collectively referred to herein as “claims 410,” and, in some instances, singularly as “claim 410”) may be provided to clearinghouse 270. Claims 410 may include interactions of a provider with clearinghouse 270, claims processor 280, or another entity responsible for paying for a beneficiary's healthcare or medical expenses, or a portion thereof. Claims 410 may be either legitimate or fraudulent.

Clearinghouse 270 may receive claims 410, may make minor changes to claims 410, and may provide claims information 420 to healthcare fraud management system 260, or to claims processor 280 and then to healthcare fraud management system 260. Claims information 420 may include provider information, beneficiary information, healthcare service information, etc. In one implementation, each claim 410 may involve a one-time exchange of claims information 420, between clearinghouse 270 and healthcare fraud management system 260, which may occur in near real-time to submission of claim 410 to clearinghouse 270 and prior to payment of claim 410. Alternatively, or additionally, each claim 410 may involve a series of exchanges of claims information 420, between clearinghouse 270 and healthcare fraud management system 260, which may occur prior to payment of claim 410.

Healthcare fraud management system 260 may receive claims information 420 from clearinghouse 270, and may obtain other information 430 regarding healthcare fraud from other systems. For example, other information 430 may include information associated with providers under investigation for possible fraudulent activities, information associated with providers who previously committed fraud, information provided by ZPICs, information provided by recovery audit contractors, and information provided by other external data sources. The information provided by the other external data sources may include an excluded provider list (EPL), a federal investigation database (FID), compromised provider and beneficiary identification (ID) numbers, compromised number contractor (CNC) information, benefit integrity unit (BIU) information, provider enrollment (PECOS) system information, and information from common working file (CWF) and claims adjudication systems. Healthcare fraud management system 260 may use claims information 420 and other information 430 to facilitate the processing of a particular claim 410.

For example, healthcare fraud management system 260 may process the particular claim 410 using sets of rules, selected based on information relating to a determined claim type and based on other information 430, to generate fraud information 440. Depending on the determined claim type associated with the particular claim 410, healthcare fraud management system 260 may select one or more of a procedure frequency rule, a geographical dispersion of services rule, a geographical dispersion of participants rule, a beneficiary frequency of provider rule, an auto summation of provider procedure time rule, a suspect beneficiary ID theft rule, an aberrant practice patterns rule, etc. In one implementation, healthcare fraud management system 260 may process the particular claim 410 against a set of rules sequentially or in parallel. Healthcare fraud management system 260 may output fraud information 440 to claims processor 280 to inform claims processor 280 whether the particular claim 410 is potentially fraudulent. Fraud information 440 may include a fraud score, a fraud report, an “accept” alert (meaning that the particular claim 410 is not fraudulent), or a “reject” alert (meaning that the particular claim 410 is potentially fraudulent or improper payments were made for the particular claim). Claims processor 280 may then decide whether to pay the particular claim 410, as indicated by reference number 450, or challenge/deny payment for the particular claim 410, as indicated by reference number 460, based on fraud information 440.

In one implementation, healthcare fraud management system 260 may output fraud information 440 to clearinghouse 270 to inform clearinghouse 270 whether the particular claim 410 is or is not fraudulent. If fraud information 440 indicates that the particular claim 410 is fraudulent, clearinghouse 270 may reject the particular claim 410 and may provide an indication of the rejection to one of provider devices 220-250.

Alternatively, or additionally, healthcare fraud management system 260 may output (e.g., after payment of the particular claim 410) fraud information 440 to a claims recovery entity (e.g., a ZPIC or a recovery audit contractor) to inform the claims recovery entity whether the particular claim 410 is or is not fraudulent. If fraud information 440 indicates that the particular claim 410 is fraudulent, the claims recovery entity may initiate a claims recovery process to recover the money paid for the particular claim 410.

Although FIG. 4 shows example components of example portion 400, in other implementations, example portion 400 may include fewer components, different components, differently arranged components, and/or additional components than those depicted in FIG. 4. Alternatively, or additionally, one or more components of example portion 400 may perform one or more tasks described as being performed by one or more other components of example portion 400.

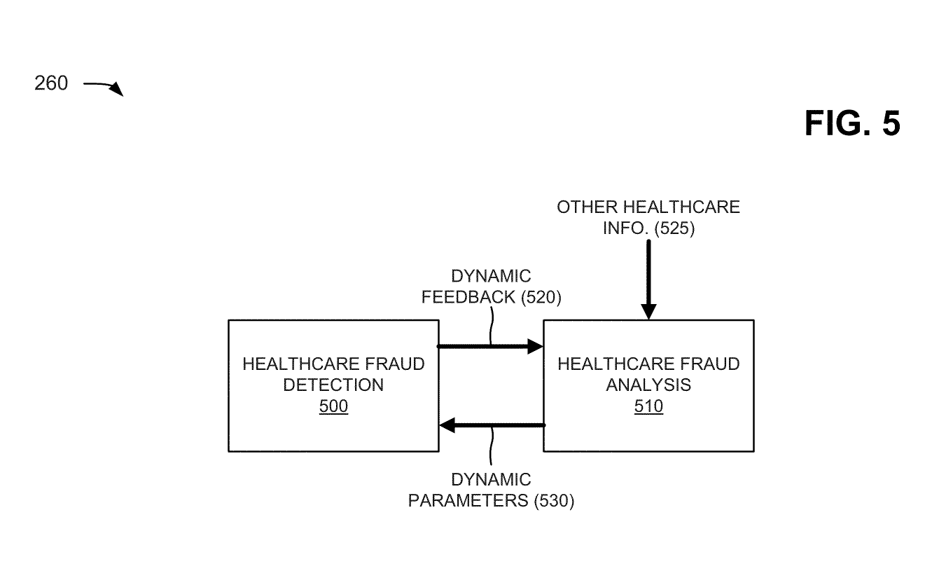

FIG. 5 is a diagram of example functional components of healthcare fraud management system 260. In one implementation, the functions described in connection with FIG. 5 may be performed by one or more components of device 300 (FIG. 3) or by one or more devices 300. As shown in FIG. 5, healthcare fraud management system 260 may include a healthcare fraud detection system 500 and a healthcare fraud analysis system 510.

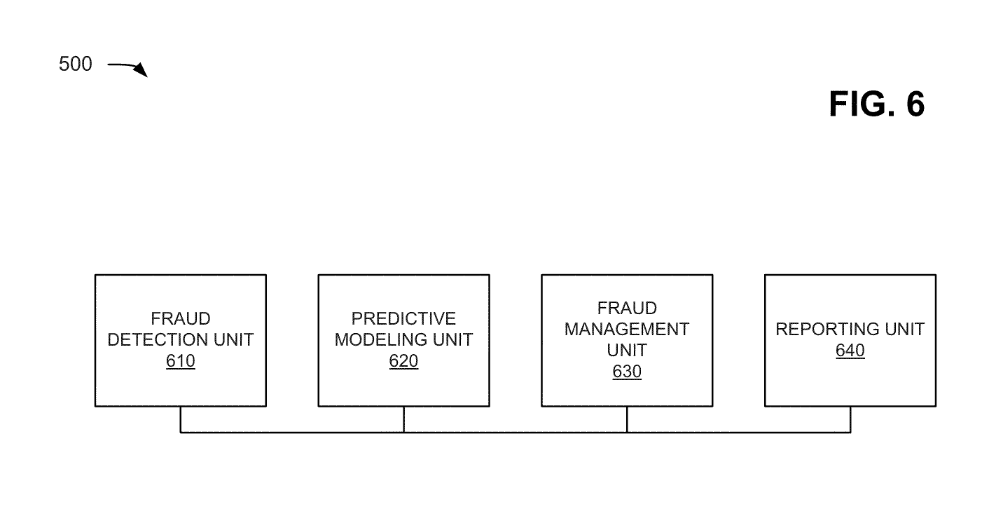

Healthcare fraud detection system 500 may perform the operations described above, in connection with FIG. 4, for healthcare fraud management system 260. Alternatively, or additionally, healthcare fraud detection system 500 may perform the operations described below in connection with FIG. 6. As shown in FIG. 5, based upon performance of these operations, healthcare fraud detection system 500 may generate dynamic feedback 520, and may provide dynamic feedback 520 to healthcare fraud analysis system 510. Dynamic feedback 520 may include other information 430, fraud information 440, information associated with adjudication (e.g., pay or deny) of claims 410, etc.

Healthcare fraud analysis system 510 may receive dynamic feedback 520 from healthcare fraud detection system 500 and other healthcare information 525, and may store dynamic feedback 520/information 525 (e.g., in a data structure associated with healthcare fraud analysis system 510). Other healthcare information 525 may include information associated with claims 410, claims information 420, information retrieved from external databases (e.g., pharmaceutical databases, blacklists of providers, blacklists of beneficiaries, healthcare databases (e.g., Thomas Reuters, Lexis-Nexis, etc.), etc.), geographical information associated with providers/beneficiaries, telecommunications information associated with providers/beneficiaries, etc.

Healthcare fraud analysis system 510 may calculate a geographic density of healthcare fraud based on dynamic feedback 520 and/or information 525, and may generate one or more geographic healthcare fraud maps based on the geographic density. Based on dynamic feedback 520 and/or information 525, healthcare fraud analysis system 510 may determine anomalous distributions of healthcare fraud, and may derive empirical estimates of procedure/treatment durations. Healthcare fraud analysis system 510 may utilize classifiers, language models, co-morbidity analysis, and/or link analysis to determine inconsistencies in dynamic feedback 520 and/or information 525.

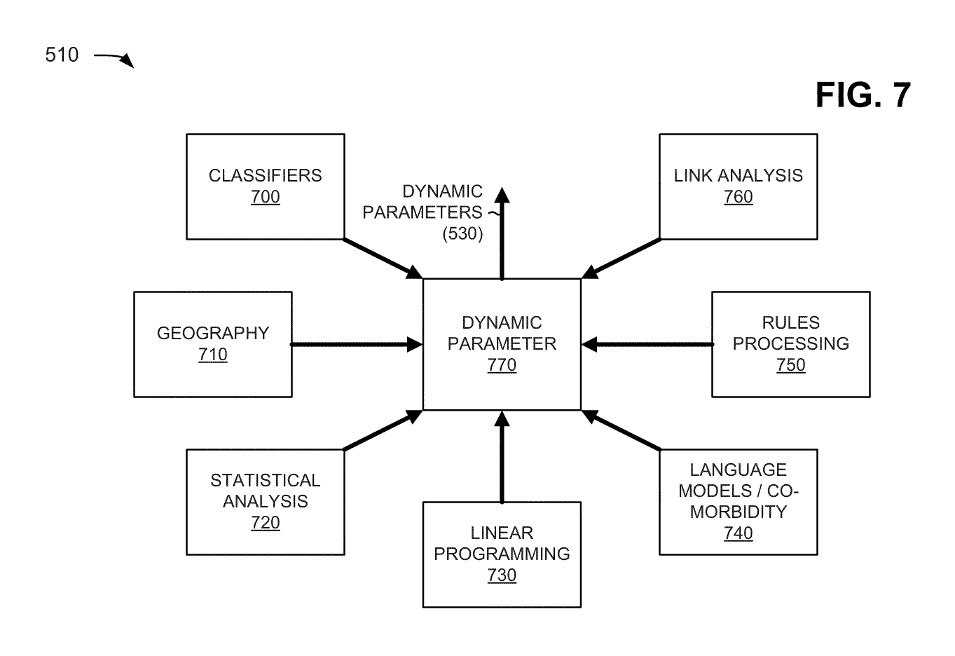

Healthcare fraud analysis system 510 may calculate dynamic parameters 530 for healthcare fraud detection system 500 based on the geographic density of healthcare fraud, the anomalous distributions of healthcare fraud, the empirical estimates, and/or the inconsistencies in dynamic feedback 520 and/or information 525. Healthcare fraud analysis system 510 may provide the calculated dynamic parameters 530 to healthcare fraud detection system 500. Dynamic parameters 530 may include parameters, such as thresholds, rules, models, etc., used by healthcare fraud detection system 500 for filtering claims 410 and/or claims information 420, detecting healthcare fraud, analyzing alerts generated for healthcare fraud, prioritizing alerts generated for healthcare fraud, etc. Further details of healthcare fraud analysis system 510 are provided below in connection with, for example, one or more of FIGS. 7-17.

Although FIG. 5 shows example functional components of healthcare fraud management system 260, in other implementations, healthcare fraud management system 260 may include fewer functional components, different functional components, differently arranged functional components, and/or additional functional components than those depicted in FIG. 5. Alternatively, or additionally, one or more functional components of healthcare fraud management system 260 may perform one or more tasks described as being performed by one or more other functional components of healthcare fraud management system 260.

FIG. 6 is a diagram of example functional components of healthcare fraud detection system 500 (FIG. 5). In one implementation, the functions described in connection with FIG. 6 may be performed by one or more components of device 300 (FIG. 3) or by one or more devices 300. As shown in FIG. 6, healthcare fraud detection system 500 may include a fraud detection unit 610, a predictive modeling unit 620, a fraud management unit 630, and a reporting unit 640.

Generally, fraud detection unit 610 may receive claims information 420 from clearinghouse 270, may receive other information 430 from other sources, and may analyze claims 410, in light of other information 430 and claim types, to determine whether claims 410 are potentially fraudulent. In one implementation, fraud detection unit 610 may generate a fraud score for a claim 410, and may classify a claim 410 as “safe,” “unsafe,” or “for review,” based on the fraud score. A “safe” claim may include a claim 410 with a fraud score that is less than a first threshold (e.g., less than 5, less than 10, less than 20, etc. within a range of fraud scores of 0 to 100, where a fraud score of 0 may represent a 0% probability that claim 410 is fraudulent and a fraud score of 100 may represent a 100% probability that the claim is fraudulent). An “unsafe” claim may include a claim 410 with a fraud score that is greater than a second threshold (e.g., greater than 90, greater than 80, greater than 95, etc. within the range of fraud scores of 0 to 100) (where the second threshold is greater than the first threshold). A “for review” claim may include a claim 410 with a fraud score that is greater than a third threshold (e.g., greater than 50, greater than 40, greater than 60, etc. within the range of fraud scores of 0 to 100) and not greater than the second threshold (where the third threshold is greater than the first threshold and less than the second threshold).

In one implementation, the first, second, and third thresholds and the range of potential fraud scores may be set by an operator of healthcare fraud detection system 500. Alternatively, or additionally, the first, second, and/or third thresholds and/or the range of potential fraud scores may be set by clearinghouse 270 and/or claims processor 280. In this case, the thresholds and/or range may vary from clearinghouse-to-clearinghouse and/or from claims processor-to-claims processor. The fraud score may represent a probability that a claim is fraudulent.

If fraud detection unit 610 determines that a claim 410 is a “safe” claim, fraud detection unit 610 may notify claims processor 280 that claims processor 280 may safely approve, or alternatively fulfill, claim 410. If fraud detection unit 610 determines that a claim 410 is an “unsafe” claim, fraud detection unit 610 may notify claims processor 280 to take measures to minimize the risk of fraud (e.g., deny claim 410, request additional information from one or more provider devices 220-250, require interaction with a human operator, refuse to fulfill all or a portion of claim 410, etc.). Alternatively, or additionally, fraud detection unit 610 may provide information regarding the unsafe claim to predictive modeling unit 620 and/or fraud management unit 630 for additional processing of claim 410. If fraud detection unit 610 determines that a claim 410 is a “for review” claim, fraud detection unit 410 may provide information regarding claim 410 to predictive modeling unit 620 and/or fraud management unit 630 for additional processing of claim 410.

In one implementation, fraud detection unit 610 may operate within the claims processing flow between clearinghouse 270 and claims processor 280, without creating processing delays. Fraud detection unit 610 may analyze and investigate claims 410 in real time or near real-time, and may refer “unsafe” claims or “for review” claims to a fraud case management team for review by clinical staff. Claims 410 deemed to be fraudulent may be delivered to claims processor 280 (or other review systems) so that payment can be suspended, pending final verification or appeal determination.

Generally, predictive modeling unit 620 may receive information regarding certain claims 410 and may analyze these claims 410 to determine whether the certain claims 410 are fraudulent. In one implementation, predictive modeling unit 620 may provide a high volume, streaming data reduction platform for claims 410. Predictive modeling unit 620 may receive claims 410, in real time or near real-time, and may apply claim type-specific predictive models, configurable edit rules, artificial intelligence techniques, and/or fraud scores to claims 410 in order to identify inappropriate (e.g., fraudulent) patterns and outliers.

With regard to data reduction, predictive modeling unit 620 may normalize and filter claims information 420 and/or other information 430 (e.g., to a manageable size), may analyze the normalized/filtered information, may prioritize the normalized/filtered information, and may present a set of suspect claims 410 for investigation. The predictive models applied by predictive modeling unit 620 may support linear pattern recognition techniques (e.g., heuristics, expert rules, etc.) and non-linear pattern recognition techniques (e.g., neural nets, clustering, artificial intelligence, etc.). Predictive modeling unit 620 may assign fraud scores to claims 410, may create and correlate alarms across multiple fraud detection methods, and may prioritize claims 410 (e.g., based on fraud scores) so that claims 410 with the highest risk of fraud may be addressed first.

Generally, fraud management unit 630 may provide a holistic, compliant, and procedure-driven operational architecture that enables extraction of potentially fraudulent healthcare claims for more detailed review. Fraud management unit 630 may refer potentially fraudulent claims to trained analysts who may collect information (e.g., from healthcare fraud detection system 500) necessary to substantiate further disposition of the claims. Fraud management unit 630 may generate key performance indicators (KPIs) that measure performance metrics for healthcare fraud detection system 500 and/or the analysts.

In one implementation, fraud management unit 630 may provide lists of prioritized healthcare claims under review with supporting aggregated data, and may provide alerts and associated events for a selected healthcare claim. Fraud management unit 630 may provide notes and/or special handling instructions for a provider and/or beneficiary associated with a claim under investigation. Fraud management unit 630 may also provide table management tools (e.g., thresholds, exclusions, references, etc.), account management tools (e.g., roles, filters, groups, etc.), and geographical mapping tools and screens (e.g., for visual analysis) for healthcare claims under review.

Generally, reporting unit 640 may generate comprehensive standardized and ad-hoc reports for healthcare claims analyzed by healthcare fraud detection system 500. For example, reporting unit 640 may generate financial management reports, trend analytics reports, return on investment reports, KPI/performance metrics reports, intervention analysis/effectiveness report, etc. Reporting unit 640 may provide data mining tools and a data warehouse for performing trending and analytics for healthcare claims. Information provided in the data warehouse may include alerts and case management data associated with healthcare claims. Such information may be available to claims analysts for trending, post data analysis, and additional claims development, such as preparing a claim for submission to program safeguard contractors (PSCs) and other authorized entities. In one example, information generated by reporting unit 640 may be used by fraud detection unit 610 and predictive modeling unit 620 to update rules, predictive models, artificial intelligence techniques, and/or fraud scores generated by fraud detection unit 610 and/or predictive modeling unit 620.

Although FIG. 6 shows example functional components of healthcare fraud detection system 500, in other implementations, healthcare fraud detection system 500 may include fewer functional components, different functional components, differently arranged functional components, and/or additional functional components than those depicted in FIG. 6. Alternatively, or additionally, one or more functional components of healthcare fraud detection system 500 may perform one or more tasks described as being performed by one or more other functional components of healthcare fraud detection system 500.

FIG. 7 is a diagram of example functional components of healthcare fraud analysis system 510 (FIG. 5). In one implementation, the functions described in connection with FIG. 7 may be performed by one or more components of device 300 (FIG. 3) or by one or more devices 300. As shown in FIG. 7, healthcare fraud analysis system 510 may include a classifiers component 700, a geography component 710, a statistical analysis component 720, a linear programming component 730, a language models/co-morbidity component 740, a rules processing component 750, a link analysis component 760, and a dynamic parameter component 770.

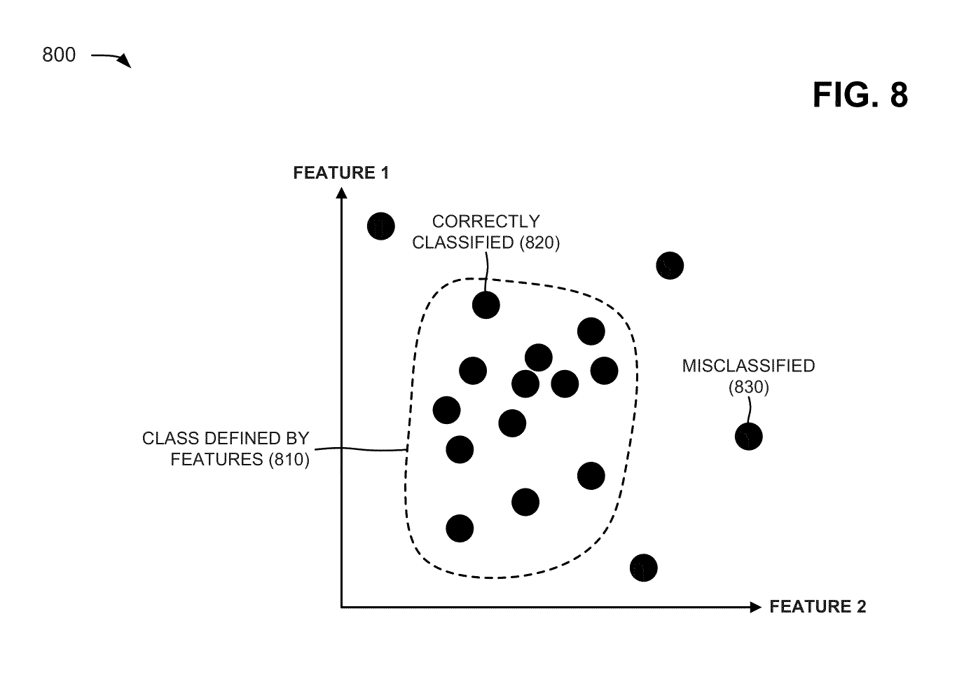

Classifiers component 700 may receive dynamic feedback 520 and/or information 525, and may generate one or more classifiers based on dynamic feedback 520 and/or information 525. The classifiers may enable prediction and/or discovery of inconsistencies in dynamic feedback 520 and/or information 525. For example, a particular classifier may identify an inconsistency when a thirty (30) year old beneficiary is receiving vaccinations typically received by an infant. In one example implementation, the classifiers may include a one-class support vector machine (SVM) model that generates a prediction and a probability for a case in dynamic feedback 520 and/or information 525. The SVM model may include a supervised learning model with associated learning algorithms that analyze data and recognize patterns, used for classification and regression analysis. A basic SVM model may take a set of input data, and may predict, for each given input, which of two possible classes forms an output, making it a non-probabilistic binary linear classifier. The classifiers may be used to check consistencies with beneficiary profiles and/or national provider identifier (NPI) profiles, and may be used to map procedures to age, procedures to gender, diagnosis to procedures, etc. Further details of geography component 710 are provided below in connection with, for example, FIG. 8.

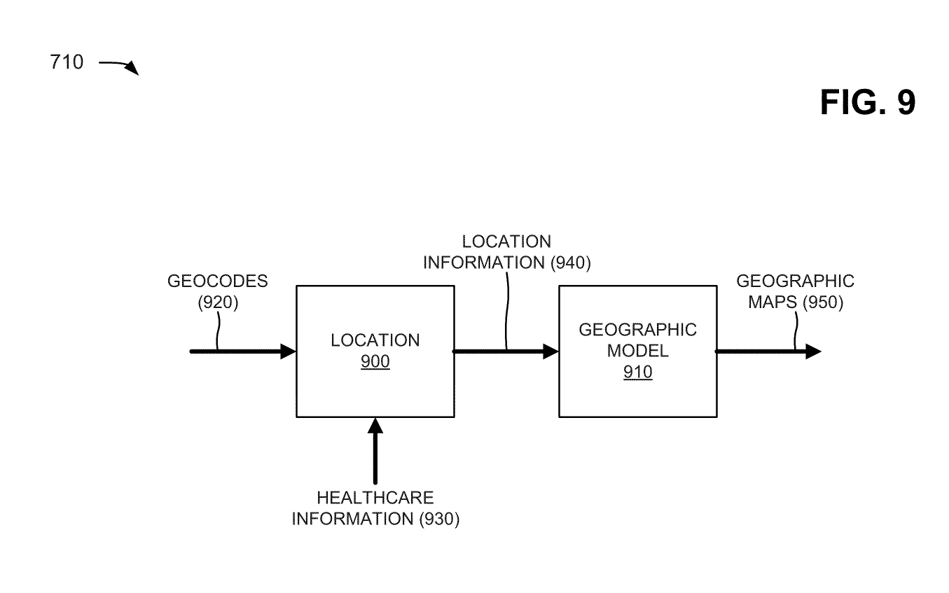

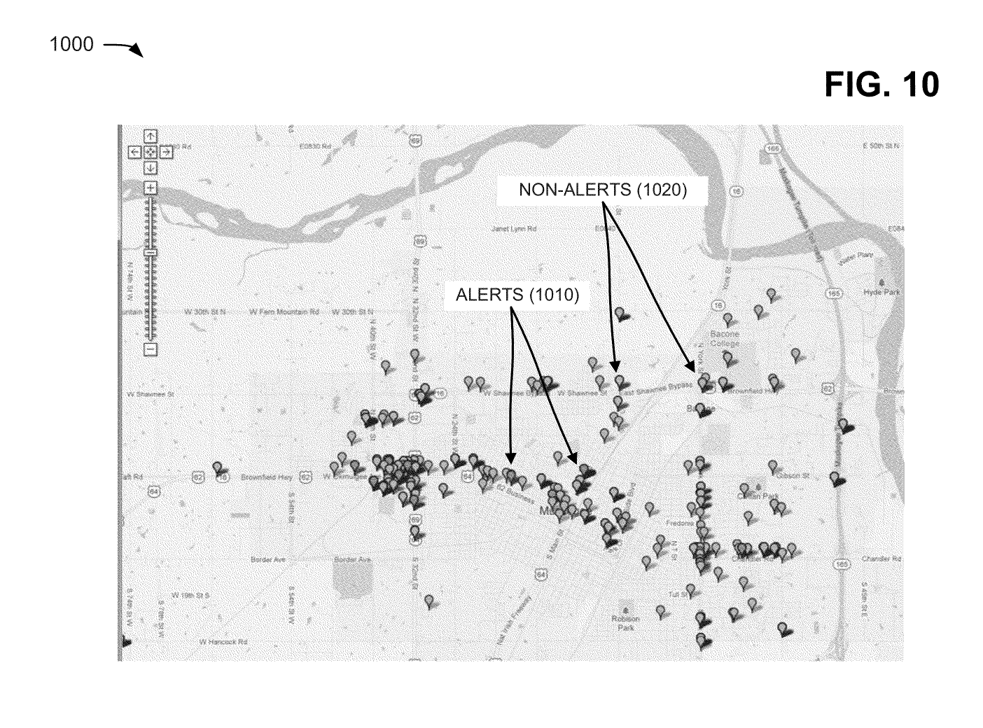

Geography component 710 may receive dynamic feedback 520 and/or information 525, and may calculate a geographic density of healthcare fraud based on dynamic feedback 520 and/or information 525. In one example, geography component 710 may receive geocodes associated with providers and beneficiaries, and may associate the geocodes with dynamic feedback 520 and/or information 525, to generate healthcare fraud location information. Geography component 710 may generate a geographic healthcare fraud map (e.g., similar to those shown in FIGS. 10-13) based on the healthcare fraud location information. Geography component 710 may output (e.g., display) and/or store the geographic healthcare fraud map. Further details of geography component 710 are provided below in connection with, for example, one or more of FIGS. 9-13.

Statistical analysis component 720 may receive dynamic feedback 520 and/or information 525, and may determine anomalous distributions of healthcare fraud based on dynamic feedback 520 and/or information 525. In one example, statistical analysis component 720 may detect anomalies in dynamic feedback 520 and/or information 525 based on procedures per beneficiary/provider; drugs per beneficiary/provider; cost per beneficiary/provider; doctors per beneficiary/provider; billing affiliations per beneficiary/provider; treatment or prescription per time for beneficiary/provider; opiates, depressants, or stimulants per beneficiary; denied/paid claims; etc. Alternatively, or additionally, statistical analysis component 720 may detect anomalies in dynamic feedback 520 and/or information 525 utilizing a time series analysis, a Gaussian univariate model, multivariate anomaly detection, etc.

A time series analysis may include methods for analyzing time series data in order to extract meaningful statistics and other characteristics of the data. For example, statistical analysis component 720 may plot a number (e.g., counts) of procedures per provider (e.g., NPI) and a cost per provider (e.g., NPI) on a graph that includes a procedure axis (e.g., a y-axis), a time axis (e.g., an x-axis), and a specialty axis (e.g., a z-axis). The graph may be used to project anomalies in dynamic feedback 520 and/or information 525.

In one example, the graph may be used to calculate a NPI score as follows:

NPI score=Sum(anomalies(count/NPI>u+3*sigma)),

where “u” is a threshold value and “sigma” is a standard deviation value. Statistical analysis component 720 may utilize the graph to project another graph that includes a procedure axis (e.g., a y-axis) and a specialty axis (e.g., a z-axis). The other graph may include a procedure “N” (e.g., an anomaly) on a day and/or month granularity basis.

In one example implementation, statistical analysis component 720 may detect anomalies (e.g., suspected fraud) by using a Gaussian univariate model of joint probability. The Gaussian univariate model may assume a normal distribution per procedure (N), and may calculate maximum likelihood estimates for “u” and “sigma.” The Gaussian univariate model may calculate joint probabilities per provider, may determine an epsilon threshold using known anomalous cases, and may identify outliers based on the epsilon threshold.

Alternatively, or additionally, statistical analysis component 720 may detect anomalies (e.g., suspected fraud) by using a multivariate model. The multivariate model may utilize probability distribution functions (PDFs) for procedures, diagnosis, drug regimen, etc., and may predict, from the PDFs, an age, gender, treatment specialty, etc. associated with beneficiaries and/or providers. The multivariate model may calculate a fit of the predictions to known data, may calculate maximum likelihood estimates, and may identify outliers. Using SVMs, the multivariate model may generate classifiers that predict age, gender, treatment specialty, etc. from the procedures, diagnosis, drug regimen, etc.

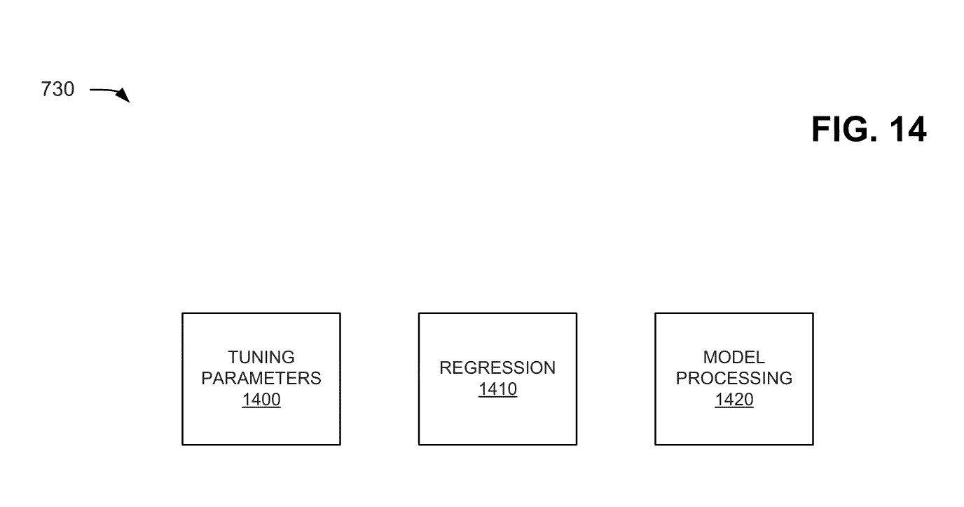

Linear programming component 730 may receive dynamic feedback 520 and/or information 525, and may derive empirical estimates of expected procedure times and/or total treatment durations based on dynamic feedback 520 and/or information 525. In one example, linear programming component 730 may derive, based on dynamic feedback 520 and/or information 525, thresholds for procedures performed in a day, a week, a month, etc. The thresholds may be derived for a total number of procedures, per procedure type (e.g., more than thirty vaccinations in a day), per specialty per procedure (e.g., more than forty vaccinations in a day for a pediatrician), per billing type, per specialty, per procedure, etc. Further details of linear programming component 730 are provided below in connection with, for example, FIG. 14.

Language models/co-morbidity component 740 may receive dynamic feedback 520 and/or information 525, and may utilize language models and/or co-morbidity analysis to determine inconsistencies in dynamic feedback 520 and/or information 525. The language models may model a flow of procedures per beneficiary as a conditional probability distribution (CPD). The language models may provide a procedural flow that predicts the most likely next procedures, and may estimate a standard of care from conditional probabilities. The language models may accurately calculate probabilities of any particular sequence of procedures, and may enable a search for alignments (e.g., known fraudulent sequences, known standard of care sequences, etc.) within a corpus of procedures. For example, the language models may determine a particular procedure flow (e.g., FirstVisit, Vacc1, Vacc2, Vacc1, FirstVisit) to be suspicious since the first visit and the first vaccination should not occur twice. The language models may assign likelihoods to any word and/or phrase in a corpus of procedures, providers, beneficiaries, and codes, and may examine and determine that low probability words and/or phrases in the corpus do not belong. The language models may examine words and/or phrases not in the corpus by determining how closely such words and/or phrases match words and/or phrases in the corpus.

The co-morbidity analysis may be based on the assumption that chronic conditions may occur together (e.g., co-morbidity) in predictable constellations. Co-morbid beneficiaries account for a lot of healthcare spending, and provide a likely area for healthcare fraud. A provider may influence treatment, in general, for one of the chronic conditions. The co-morbidity analysis may analyze the constellation of co-morbidities for a population of beneficiaries (e.g., patients of a suspect provider), and may calculate a likelihood of co-morbidity (e.g., a co-morbidity risk). The co-morbidity analysis may assume that a fraudulent provider may not control a medical constellation for a beneficiary, especially a co-morbid beneficiary. Therefore, the co-morbidity analysis may assume that a provider's beneficiaries should conform to a co-morbid distribution that is difficult for a single provider to influence.

Rules processing component 750 may receive dynamic feedback 520 and/or information 525, and may derive one or more rules based on dynamic feedback 520 and/or information 525. In one example, the rules may include general rules, provider-specific rules, beneficiary-specific rules, claim attribute specific rules, single claim rules, multi-claim rules, heuristic rules, pattern recognition rules, and/or other types of rules. Some rules may be applicable to all claims (e.g., general rules may be applicable to all claims), while other rules may be applicable to a specific set of claims (e.g., provider-specific rules may be applicable to claims associated with a particular provider). Rules may be used to process a single claim (meaning that the claim may be analyzed for fraud without considering information from another claim) or may be used to process multiple claims (meaning that the claim may be analyzed for fraud by considering information from another claim). Rules may also be applicable for multiple, unaffiliated providers (e.g., providers having no business relationships) or multiple, unrelated beneficiaries (e.g., beneficiaries having no familial or other relationship).

Link analysis component 760 may receive dynamic feedback 520 and/or information 525, and may utilize link analysis to determine inconsistencies in dynamic feedback 520 and/or information 525. In one example, the link analysis may include building a social graph of beneficiaries and providers, and extracting relationships (e.g., links between beneficiaries and providers) from the social graph. The link analysis may examine links related to existing healthcare fraud, and apply additional tests to determine whether collusion exists. If a probability threshold of collusion is reached, the link analysis may identify a claim as fraudulent. In one implementation, the link analysis may provide graphical analysis, graphical statistics, visualization, etc. for the social graph.

Dynamic parameter component 770 may receive the identified inconsistencies in dynamic feedback 520 and/or information 525 from classifiers component 700, language models/co-morbidity component 740, and/or link analysis component 760. Dynamic parameter component 770 may receive the geographic density of healthcare fraud from geography component 710, and may receive the anomalous distributions of healthcare fraud from statistical analysis component 720. Dynamic parameter component 770 may receive the empirical estimates of expected procedure times and/or total treatment durations from linear programming component 730, and may receive one or more rules from rules processing component 750.

Dynamic parameter component 770 may calculate dynamic parameters 530 based on the identified inconsistencies in dynamic feedback 520 and/or information 525, the geographic density of healthcare fraud, the anomalous distributions of healthcare fraud, and/or the empirical estimates of expected procedure times and/or total treatment durations. Dynamic parameter component 770 may provide dynamic parameters 530 to healthcare fraud detection system 500 (not shown).

In one example implementation, dynamic parameter component 770 may utilize a Bayesian belief network (BBN), a hidden Markov model (HMM), a conditional linear Gaussian model, a probable graph model (PGM), etc. to calculate dynamic parameters 530. The Bayesian belief network may provide full modeling of joint probability distributions with dependencies, may provide inference techniques (e.g., exact inference, approximate inference, etc.), and may provide methods for learning both dependency structure and distributions.

Alternatively, or additionally, dynamic parameter component 770 may derive BBN models for the most expensive chronic diseases (e.g., hypertension, diabetes, heart disease, depression, chronic obstructive pulmonary disease (COPD), etc.) in terms of standard treatments within a beneficiary population. Dynamic parameter component 770 may use such BBN models to infer a likelihood that a treatment falls outside of a standard of care, and thus constitutes fraud, waste, or abuse (FWA).

Alternatively, or additionally, dynamic parameter component 770 may calculate a design matrix based on the identified inconsistencies in dynamic feedback 520 and/or information 525, the geographic density of healthcare fraud, the anomalous distributions of healthcare fraud, and/or the empirical estimates of expected procedure times and/or total treatment durations. The design matrix may be used to learn a BBN model and regressors. For example, if an m-by-n matrix (X) represents the identified inconsistencies, the geographic density, the anomalous distributions, and/or the empirical estimates, and an n-by-1 matrix (W) represents regressors, a matrix (Y) of adjudication, rank, and score may be provided by:

$$X * W = Y \\ [ \begin{matrix}{x}_{11} & {x}_{12} & … & {x}_{1 m} \\ {x}_{21} & {x}_{22} & … & {x}_{2 m} \\ … & … & … & … \\ {x}_{n 1} & {x}_{n 2} & … & {x}_{nm}\end{matrix} ] * [ \begin{matrix}{w}_{1} \\ {w}_{2} \\ … \\ {w}_{n}\end{matrix} ] = [ \begin{matrix}{y}_{1} \\ {y}_{2} \\ … \\ {y}_{n}\end{matrix} ] .$$

Although FIG. 7 shows example functional components of healthcare fraud analysis system 510, in other implementations, healthcare fraud analysis system 510 may include fewer functional components, different functional components, differently arranged functional components, and/or additional functional components than those depicted in FIG. 7. Alternatively, or additionally, one or more functional components of healthcare fraud analysis system 510 may perform one or more tasks described as being performed by one or more other functional components of healthcare fraud analysis system 510.

FIG. 8 is a diagram of example operations 800 capable of being performed by classifiers component 700 (FIG. 7). Classifiers component 700 may receive dynamic feedback 520 and/or information 525, and may generate one or more classifiers based on dynamic feedback 520 and/or information 525. The classifiers may enable prediction and/or discovery of inconsistencies in dynamic feedback 520 and/or information 525. For example, as shown in FIG. 8, classifiers component 700 may utilize a one-class SVM model to produce a class 810 defined by features (e.g., a cardiology specialty) in dynamic feedback 520 and/or information 525. The SVM model may include a supervised learning model with associated learning algorithms that analyze data and recognize patterns, used for classification and regression analysis. A basic SVM model may take a set of input data, and may predict, for each given input, which of two possible classes forms an output, making it a non-probabilistic binary linear classifier. Class 810 may include a prediction and a probability for each case in dynamic feedback 520 and/or information 525, and may be plotted on a graph that includes a first feature (y-axis) (e.g., procedure types) and a second feature (x-axis) (e.g., common diagnosis).

Classifiers component 700 may then plot cases of dynamic feedback 520 and/or information 525 in the graph, and may determine whether or not a case falls within class 810. For example, as shown in FIG. 8, a number of cases may be correctly classified 820 (e.g., cases handled by a correctly classified cardiologist), and a number of cases may be misclassified 830 (e.g., cases handled by a misclassified cardiologist). Misclassified 830 cases may include a predefined percentage of the cases that are anomalous, and may be used to determine inconsistencies in dynamic feedback 520 and/or information 525. In one example implementation, classifiers component 700 may utilize classifiers to check consistencies with beneficiary profiles and/or NPI profiles, and to map procedures to age, procedures to gender, diagnosis to procedures, etc.

Although FIG. 8 shows example operations capable of being performed by classifiers component 700, in other implementations, classifiers component 700 may perform fewer operations, different operations, and/or additional operations than those depicted in FIG. 8.

FIG. 9 is a diagram of example functional components of geography component 710 (FIG. 7). In one implementation, the functions described in connection with FIG. 9 may be performed by one or more components of device 300 (FIG. 3) or by one or more devices 300. As shown in FIG. 9, geography component 710 may include a location component 900 and a geographic model component 910.

Location component 900 may receive geocodes 920 associated with providers and beneficiaries, and may receive healthcare information 930, such as information provided in dynamic feedback 520 and/or information 525 (FIG. 5). Location component 900 may associate geocodes 920 with healthcare information 930 to generate healthcare fraud location information 940. In one example, location component 900 may utilize interpolation and prediction of healthcare fraud risk over a geographical area to generate healthcare fraud location information 940. Location component 900 may provide healthcare fraud location information 940 to geographic model component 910.

Geographic model component 910 may receive healthcare fraud location information 940, and may generate geographic healthcare fraud maps 950 (e.g., similar to those shown in FIGS. 10-13) based on healthcare fraud location information 940. Geographic model component 910 may output (e.g., display) and/or store geographic healthcare fraud maps 950. In one example, geographic model component 910 may create geographic healthcare fraud maps 950 based on density of beneficiaries, density of specialties, density of fraud, density of expenditures for beneficiaries and/or providers. Geographic model component 910 may identify anomalies in maps 950 when a threshold (e.g., a particular percentage of a map surface) includes alerts for beneficiaries and/or providers.

Although FIG. 9 shows example functional components of geography component 710, in other implementations, geography component 710 may include fewer functional components, different functional components, differently arranged functional components, and/or additional functional components than those depicted in FIG. 9. Alternatively, or additionally, one or more functional components of geography component 710 may perform one or more tasks described as being performed by one or more other functional components of geography component 710.

FIGS. 10-13 are diagrams of example geographic maps capable of being generated by geography component 710 (FIGS. 7 and 9). FIG. 10 is a diagram of a geographic map 1000 that shows a geographic density estimation for fraudulent providers and/or beneficiaries. As shown in FIG. 10, geographic map 1000 may include information associated with a geographical area, such as street information (e.g., Border Ave), destination information (e.g., parks, colleges, etc.), geographical information (e.g., rivers), etc. As further shown, alerts 1010 and non-alerts 1020 for beneficiaries and/or providers may be placed on geographic map 1000. In some implementations, alerts 1010 may be represented on geographic map 1000 in a different manner than non-alerts 1020 (e.g., using a different color, shape, text, etc.). If alerts 1010 occur in a similar location of geographic map 1000, this may provide an indication of a healthcare fraud risk area (e.g., a fraud region).

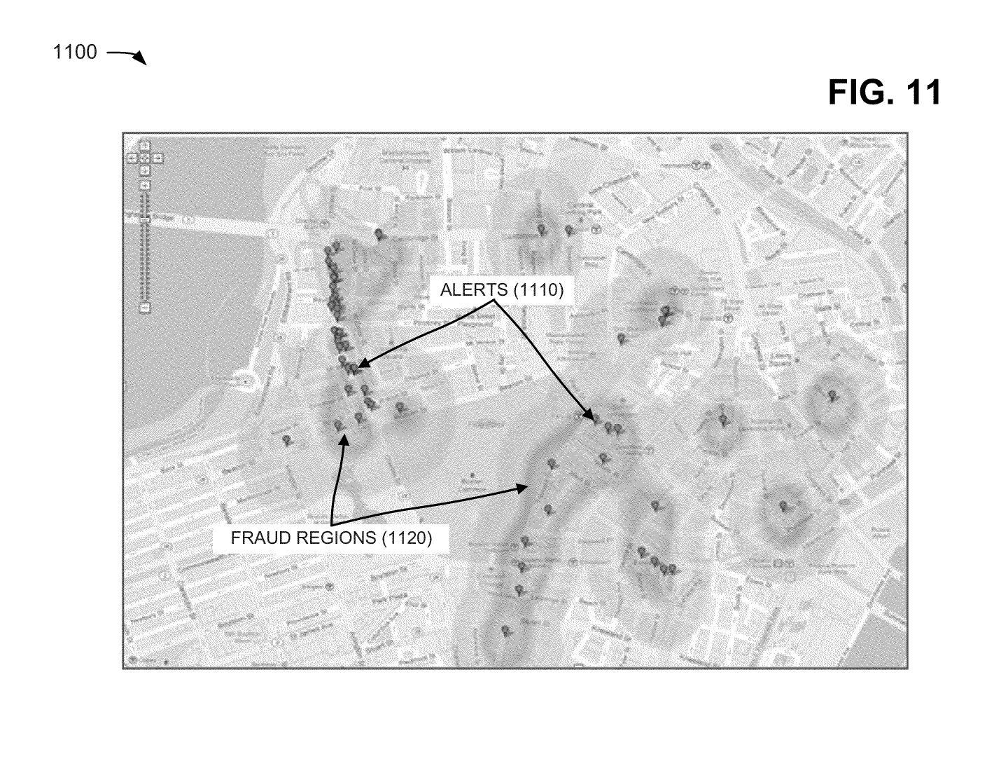

FIG. 11 is a diagram of a geographic map 1100 that shows a geographic density of fraudulent providers and/or beneficiaries. As shown in FIG. 11, geographic map 1100 may include information associated with a geographical area, such as street information (e.g., Beacon Street, Congress Street, etc.), destination information (e.g., hospitals, colleges, etc.), geographical information (e.g., ponds, waterways, etc.), etc. As further shown, alerts 1110 for beneficiaries and/or providers may be placed on geographic map 1100. If alerts 1110 occur in similar locations of geographic map 1100, this may provide indications (e.g., heat map surfaces) of healthcare fraud risk areas (e.g., fraud regions 1120). In one example, the heat map surfaces of geographic map 1100 may be highlighted in different colors based on fraud density. If an organization moves from one location to another location, the heat map surfaces may enable the organization to be identified as a fraudulent organization.

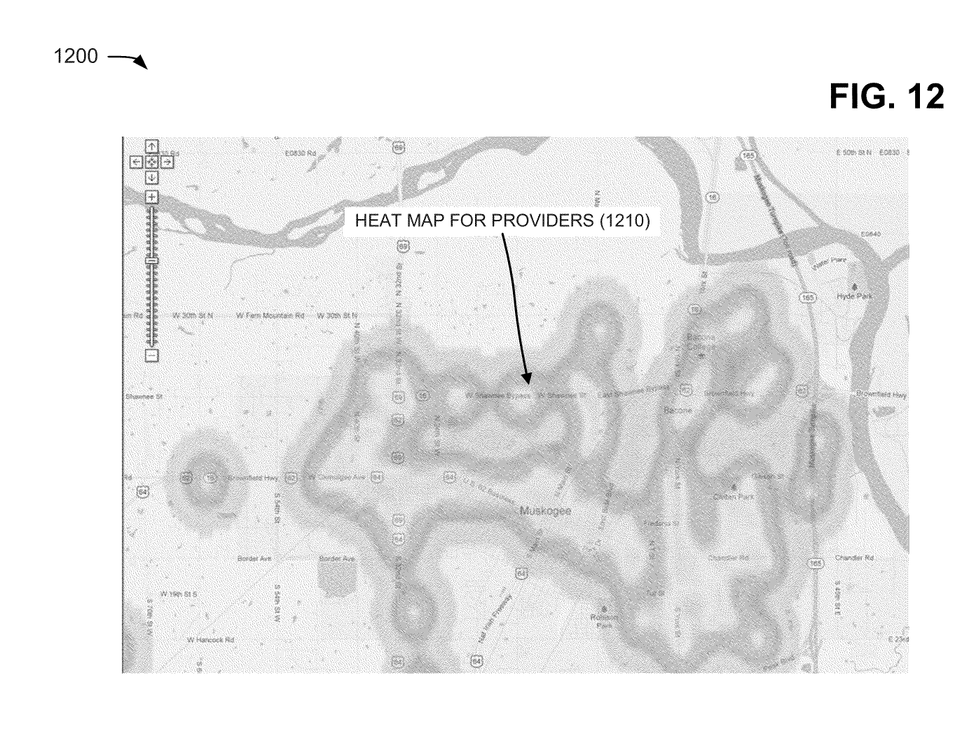

FIG. 12 is a diagram of a geographic map 1200 that shows a geographic density estimation of fraudulent providers and/or beneficiaries. As shown in FIG. 12, geographic map 1200 may include information associated with a geographical area, such as street information (e.g., Border Ave), destination information (e.g., parks), geographical information (e.g., waterways), etc. As further shown, geographic map 1200 may provide a heat map 1210 for fraudulent providers. Heat map 1210 may provide indications of healthcare fraud risk areas for providers in the geographical area. In one example, heat map 1210 of geographic map 1200 may be highlighted in different colors based on fraud density.

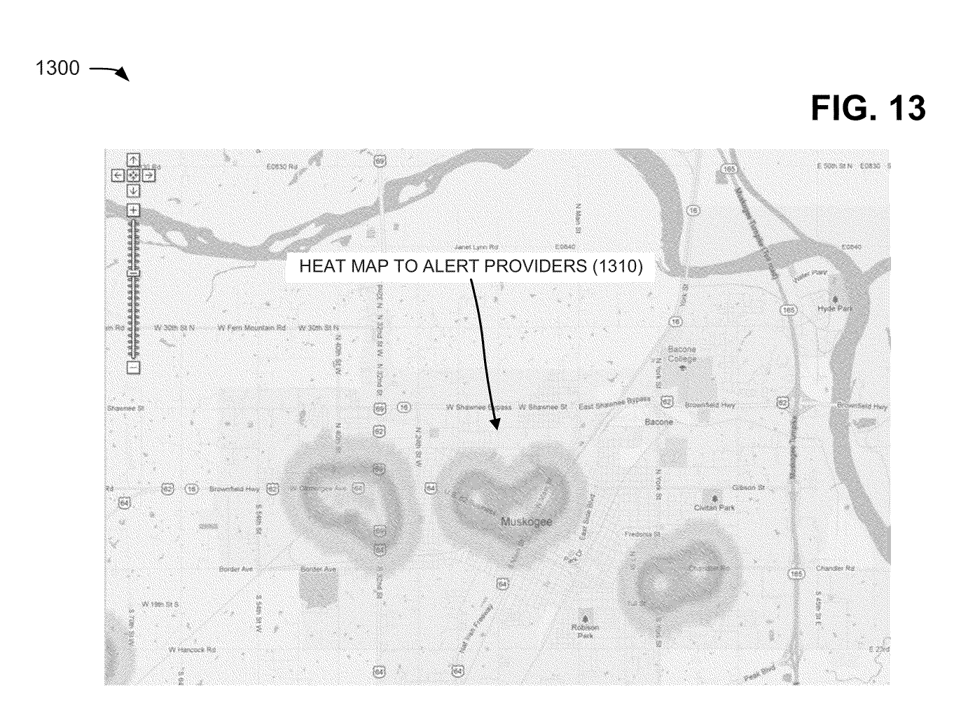

FIG. 13 is a diagram of a geographic map 1300 that shows a geographic density estimation of fraudulent providers and/or beneficiaries. As shown in FIG. 13, geographic map 1300 may include information associated with a geographical area, such as street information (e.g., Border Ave), destination information (e.g., parks, colleges, etc.), geographical information (e.g., waterways), etc. As further shown, geographic map 1300 may provide a heat map 1310 to alert providers about fraudulent beneficiaries. Heat map 1310 may provide indications of healthcare fraud risk areas for beneficiaries in the geographical area. In one example, heat map 1310 of geographic map 1300 may be highlighted in different colors based on fraud density.

Although FIGS. 10-13 show example information of geographic maps 1000-1300, in other implementations, geographic maps 1000-1300 may include less information, different information, differently arranged information, and/or additional information than depicted in FIGS. 10-13.

FIG. 14 is a diagram of example functional components of linear programming component 730 (FIG. 7). In one implementation, the functions described in connection with FIG. 14 may be performed by one or more components of device 300 (FIG. 3) or by one or more devices 300. As shown in FIG. 14, linear programming component 730 may include a tuning parameters component 1400, a regression component 1410, and a model processing component 1420.

Tuning parameters component 1400 may derive empirical estimates of expected procedure times and/or total treatment durations based on dynamic feedback 520 and/or information 525 (FIG. 5). In one example, tuning parameters component 1400 may derive, based on dynamic feedback 520 and/or information 525, thresholds for procedures performed in a day, a week, a month, etc. The thresholds may be derived for a total number of procedures, per procedure type (e.g., more than thirty vaccinations in a day), per specialty per procedure (e.g., more than forty vaccinations in a day for a pediatrician), per billing type, per specialty, per procedure, etc.

Regression component 1410 may derive empirical estimates of fraud impact based on dynamic feedback 520 and/or information 525 (FIG. 5). In one example, regression component 1410 may perform simple regression studies on dynamic feedback 520 and/or information 525, and may establish the estimates of fraud impact based on the simple regression studies.

Model processing component 1420 may include a data structure (e.g., provided in a secure cloud computing environment) that stores one or more healthcare fraud models. Model processing component 1420 may build and test the one or more healthcare fraud models, and may store the models in a particular language (e.g., a predictive model markup language (PMML)). Model processing component 1420 may enable the healthcare fraud models to participate in decision making so that a policy-based decision (e.g., voting, winner take all, etc.) may be made.

Although FIG. 14 shows example functional components of linear programming component 730, in other implementations, linear programming component 730 may include fewer functional components, different functional components, differently arranged functional components, and/or additional functional components than those depicted in FIG. 14. Alternatively, or additionally, one or more functional components of linear programming component 730 may perform one or more tasks described as being performed by one or more other functional components of linear programming component 730.

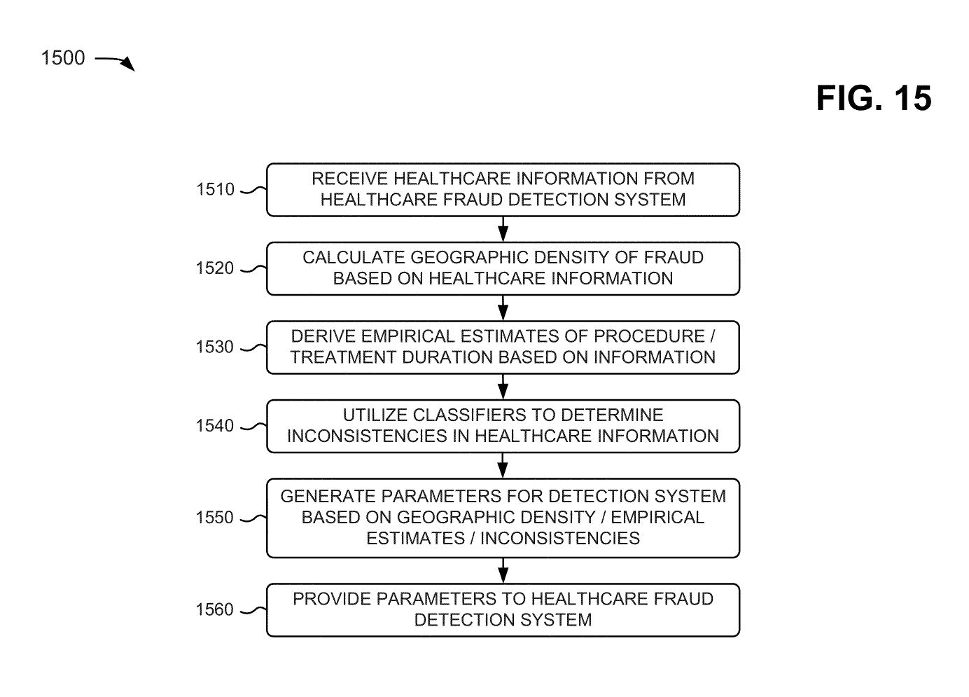

FIGS. 15-17 are flowcharts of an example process 1500 for detecting healthcare fraud based on statistics, learning, and parameters. In one implementation, process 1500 may be performed by one or more components/devices of healthcare fraud management system 260. Alternatively, or additionally, one or more blocks of process 1500 may be performed by one or more other components/devices, or a group of components/devices including or excluding healthcare fraud management system 260.

As shown in FIG. 15, process 1500 may include receiving healthcare information from a healthcare fraud detection system (block 1510), and calculating a geographic density of fraud based on the healthcare information (block 1520). For example, in an implementation described above in connection with FIG. 5, healthcare fraud detection system 500 may generate dynamic feedback 520, and may provide dynamic feedback 520 to healthcare fraud analysis system 510. Dynamic feedback 520 may include other information 430, fraud information 440, information associated with adjudication (e.g., pay or deny) of claims 410, etc. Healthcare fraud analysis system 510 may receive dynamic feedback 520 from healthcare fraud detection system 500 and/or information 525, and may store dynamic feedback 520/information 525 (e.g., in a data structure associated with healthcare fraud analysis system 510). Healthcare fraud analysis system 510 may calculate a geographic density of healthcare fraud based on dynamic feedback 520 and/or information 525.

As further shown in FIG. 15, process 1500 may include deriving empirical estimates of procedure and treatment duration based on the healthcare information (block 1530), and utilizing classifiers to determine inconsistencies in the healthcare information (block 1540). For example, in an implementation described above in connection with FIG. 7, linear programming component 730 may receive dynamic feedback 520 and/or information 525, and may derive empirical estimates of expected procedure times and/or total treatment durations based on dynamic feedback 520 and/or information 525. Classifiers component 700 may receive dynamic feedback 520 and/or information 525, and may generate one or more classifiers based on dynamic feedback 520 and/or information 525. The classifiers may enable prediction and/or discovery of inconsistencies in dynamic feedback 520 and/or information 525. In one example, the classifiers may include a one-class SVM model that generates a prediction and a probability for a case in dynamic feedback 520 and/or information 525.

Returning to FIG. 15, process 1500 may include generating parameters for the healthcare fraud detection system based on the geographic density, the empirical estimates, and the inconsistencies (block 1550), and providing the parameters the healthcare fraud detection system (block 1560). For example, in an implementation described above in connection with FIG. 7, dynamic parameter component 770 may calculate dynamic parameters 530 based on the identified inconsistencies in dynamic feedback 520 and/or information 525, the geographic density of healthcare fraud, and/or the empirical estimates of expected procedure times and/or total treatment durations. Dynamic parameter component 770 may provide dynamic parameters 530 to healthcare fraud detection system 500. In one example, dynamic parameter component 770 may utilize a BBN, a HMM, a conditional linear Gaussian model, etc. to calculate dynamic parameters 530.

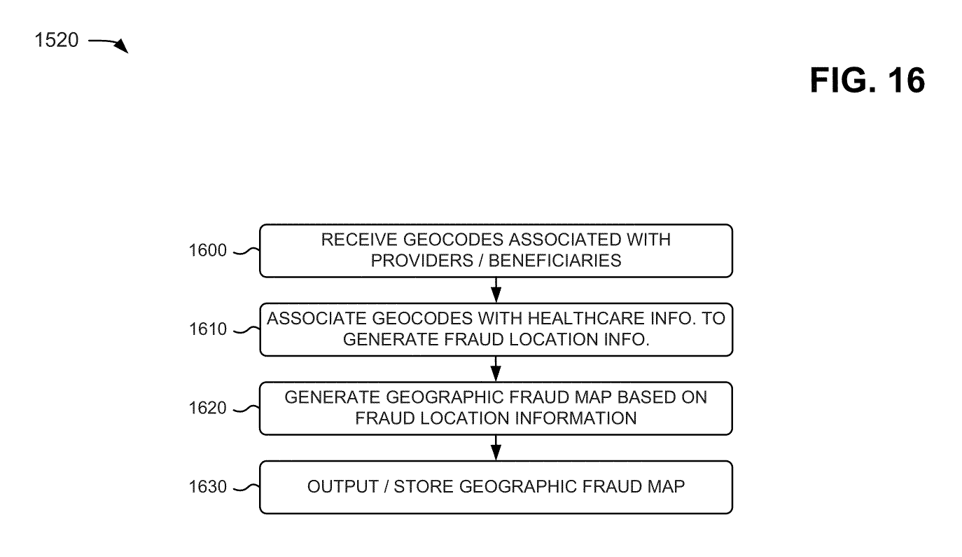

Process block 1520 may include the process blocks depicted in FIG. 16. As shown in FIG. 16, process block 1520 may include receiving geocodes associated with providers and beneficiaries (block 1600), associating the geocodes with the healthcare information to generate fraud location information (block 1610), generating a geographic fraud map based on the fraud location information (block 1620), and outputting and/or storing the geographic fraud map (block 1630). For example, in an implementation described above in connection with FIG. 7, geography component 710 may receive geocodes associated with providers and beneficiaries, and may associate the geocodes with dynamic feedback 520 and/or information 525, to generate healthcare fraud location information. Geography component 710 may generate a geographic healthcare fraud map based on the healthcare fraud location information. Geography component 710 may output (e.g., display) and/or store the geographic healthcare fraud map.

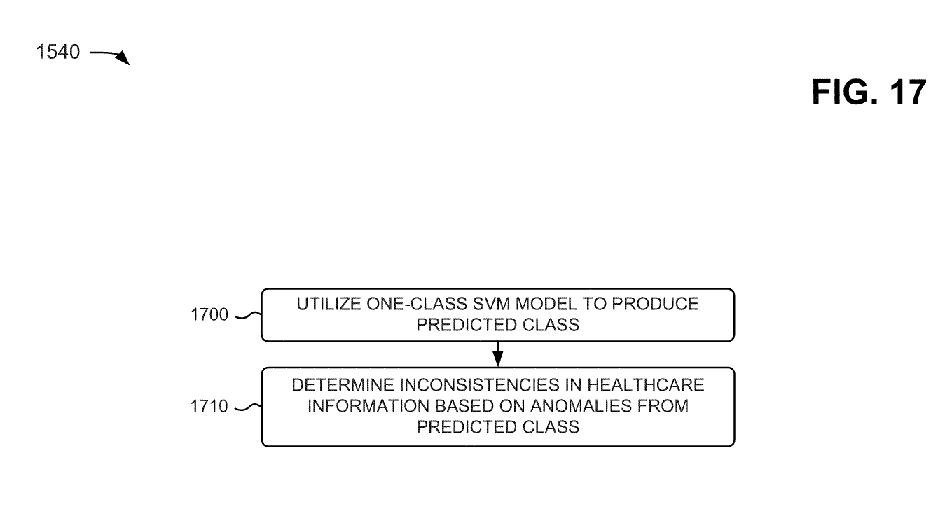

Process block 1540 may include the process blocks depicted in FIG. 17. As shown in FIG. 17, process block 1540 may include utilizing a one-class SVM model to produce a predicted class (block 1700), and determining the inconsistencies in the healthcare information based on anomalies from the predicted class (block 1710). For example, in an implementation described above in connection with FIG. 8, classifiers component 700 may utilize a one-class SVM model to produce class 810 defined by features (e.g., a cardiology specialty) in dynamic feedback 520 and/or information 525. Class 810 may include a prediction and a probability for each case in dynamic feedback 520 and/or information 525, and may be plotted on a graph that includes a first feature (y-axis) (e.g., procedure types) and a second feature (x-axis) (e.g., common diagnosis). Classifiers component 700 may then plot cases of dynamic feedback 520 and/or information 525 in the graph, and may determine whether or not a case falls within class 810. For example, a number of cases may be correctly classified 820 (e.g., cases handled by a correctly classified cardiologist), and a number of cases may be misclassified 830 (e.g., cases handled by a misclassified cardiologist). Misclassified 830 cases may include a predefined percentage of the cases that are anomalous, and may be used to determine inconsistencies in dynamic feedback 520 and/or information 525.

The foregoing description of implementations provides illustration and description, but is not intended to be exhaustive or to limit the implementations to the precise form disclosed. Modifications and variations are possible in light of the above teachings or may be acquired from practice of the implementations.

For example, while series of blocks have been described with regard to FIGS. 15-17, the blocks and/or the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the implementations may be implemented as a “component” that performs one or more functions. This component may include hardware, such as a processor, an application-specific integrated circuit (ASIC), or a field-programmable gate array (FPGA), or a combination of hardware and software.

Even though particular combinations of features are recited in the claims and/or disclosed in the specification, these combinations are not intended to limit the disclosure of the specification. In fact, many of these features may be combined in ways not specifically recited in the claims and/or disclosed in the specification. Although each dependent claim listed below may directly depend on only one other claim, the disclosure of the specification includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by one or more devices, healthcare information;
calculating, by the one or more devices, a geographic density of healthcare fraud based on the healthcare information;
deriving, by the one or more devices, empirical estimates of procedure and treatment durations based on the healthcare information;
utilizing, by the one or more devices, classifiers to determine inconsistencies in the healthcare information;
generating, by the one or more devices, parameters for a healthcare fraud detection system based on the geographic density, the empirical estimates, and the inconsistencies; and
providing, by the one or more devices, the parameters to the healthcare fraud detection system.

2. The method of claim 1, where the one or more devices are provided in a healthcare fraud analysis system.

3. The method of claim 2, where the healthcare fraud analysis system and the healthcare fraud detection system are provided in a healthcare fraud management system.

4. The method of claim 1, where calculating the geographic density of healthcare fraud comprises:
receiving geocodes associated with providers or beneficiaries;
associating the geocodes with the healthcare information to generate healthcare fraud location information;
generating a geographic healthcare fraud map based on the healthcare fraud location information; and
outputting or storing the geographic healthcare fraud map.

5. The method of claim 4, where the geographic healthcare fraud map includes a heat map region that identifies a location of healthcare fraud in a geographical area.

6. The method of claim 1, where deriving the empirical estimates of procedure and treatment durations comprises:
deriving thresholds for procedures and treatments performed in a day, a week, or a month, where the thresholds are derived for a total number of procedures, per procedure type, per specialty per procedure, per billing type, per specialty, or per procedure.

7. The method of claim 1, where utilizing the classifiers to determine the inconsistencies comprises:
utilizing a one-class support vector machine (SVM) model to produce a predicted class; and
determining the inconsistencies in the healthcare information based on anomalies from the predicted class.

8. The method of claim 1, where generating the parameters for the healthcare fraud detection system comprises:
utilizing a Bayesian belief network (BBN), a hidden Markov model (HMM), a conditional linear Gaussian model, or a probable graph model (PGM) to generate the parameters.

9. A system, comprising:
one or more processors to:
receive healthcare information,
calculate a geographic density of healthcare fraud based on the healthcare information,
derive empirical estimates of procedure and treatment durations based on the healthcare information,
utilize classifiers to determine inconsistencies in the healthcare information,
generate parameters for a healthcare fraud detection system based on the geographic density, the empirical estimates, and the inconsistencies, and
provide the parameters to the healthcare fraud detection system.

10. The system of claim 9, where, when calculating the geographic density of healthcare fraud, the one or more processors are further to:
receive geocodes associated with providers or beneficiaries,
associate the geocodes with the healthcare information to generate healthcare fraud location information,
generate a geographic healthcare fraud map based on the healthcare fraud location information, and
output or store the geographic healthcare fraud map.

11. The system of claim 10, where the geographic healthcare fraud map includes a heat map region that identifies a location of healthcare fraud in a geographical area.

12. The system of claim 9, where, when deriving the empirical estimates of procedure and treatment durations, the one or more processors are further to:
derive thresholds for procedures and treatments performed in a day, a week, or a month, where the thresholds are derived for a total number of procedures, per procedure type, per specialty per procedure, per billing type, per specialty, or per procedure.

13. The system of claim 9, where, when utilizing the classifiers to determine the inconsistencies, the one or more processors are further to:
utilize a one-class support vector machine (SVM) model to produce a predicted class, and
determine the inconsistencies in the healthcare information based on anomalies from the predicted class.

14. The system of claim 9, where, when generating the parameters for the healthcare fraud detection system, the one or more processors are further to:
utilize a Bayesian belief network (BBN), a hidden Markov model (HMM), a conditional linear Gaussian model, or a probable graph model (PGM) to generate the parameters.

15. One or more computer-readable media, comprising:
one or more instructions that, when executed by at least one processor of a healthcare fraud management system, cause the at least one processor to:
receive healthcare information,
calculate a geographic density of healthcare fraud based on the healthcare information,
derive empirical estimates of procedure and treatment durations based on the healthcare information,
utilize classifiers to determine inconsistencies in the healthcare information,
generate parameters for a healthcare fraud detection system based on the geographic density, the empirical estimates, and the inconsistencies, and
provide the parameters to the healthcare fraud detection system.

16. The media of claim 15, further comprising:
one or more instructions that, when executed by the at least one processor, cause the at least one processor to:
receive geocodes associated with providers or beneficiaries,
associate the geocodes with the healthcare information to generate healthcare fraud location information,
generate a geographic healthcare fraud map based on the healthcare fraud location information, and
output or store the geographic healthcare fraud map.

17. The media of claim 16, where the geographic healthcare fraud map includes a heat map region that identifies a location of healthcare fraud in a geographical area.

18. The media of claim 15, further comprising:
one or more instructions that, when executed by the at least one processor, cause the at least one processor to:
derive thresholds for procedures and treatments performed in a day, a week, or a month, where the thresholds are derived for a total number of procedures, per procedure type, per specialty per procedure, per billing type, per specialty, or per procedure.

19. The media of claim 15, further comprising:
one or more instructions that, when executed by the at least one processor, cause the at least one processor to:
utilize a one-class support vector machine (SVM) model to produce a predicted class, and
determine the inconsistencies in the healthcare information based on anomalies from the predicted class.

20. The media of claim 15, further comprising:
one or more instructions that, when executed by the at least one processor, cause the at least one processor to:
utilize a Bayesian belief network (BBN), a hidden Markov model (HMM), a conditional linear Gaussian model, or a probable graph model (PGM) to generate the parameters.
